(19) United States
(12) Patent Application Publication
(10) Pub. No.: US 2025/0149737 A1
(43) Pub. Date: May 8, 2025

(54) MXENE-POLYMER SEPARATORS FOR LI-ION BATTERIES

(71) Applicant: Drexel University, Philadelphia, PA (US)

(72) Inventors: Yury GOGOTSI, Warminster, PA (US); Xu XIAO, Philadelphia, PA (US); Wei YAO, Philadelphia, PA (US); Jun TANG, Philadelphia, PA (US)

(21) Appl. No.: 18/953,152

(22) Filed: Nov. 20, 2024

Related U.S. Application Data
(63) Continuation of application No. 17/613,672, filed on Nov. 23, 2021, now abandoned.
(60) Provisional application No. 62/852,628, filed on May 24, 2019.

(51) Int. Cl. H01M 50/449; H01M 4/02; H01M 4/134; H01M 10/0525; H01M 50/417; H01M 50/434

(52) U.S. Cl. CPC H01M 50/449; H01M 4/134; H01M 10/0525; H01M 50/417; H01M 50/434; H01M 2004/027

(57) ABSTRACT

This disclosure is directed to composites comprising a polymeric film coated on one or both sides with a MXene material, as well as lithium metal electrodes and components thereof, including MXene-polymer composite separators.

### RELATED APPLICATIONS

The present application is a continuation of U.S. patent application Ser. No. 17/613,672 (filed Nov. 23, 2021); which is the National Stage Application of International Patent Application No. PCT/US2020/034318 (filed May 22, 2020); which claims priority to and the benefit of U.S. patent application No. 62/852,628, “MXene-Polymer Separators For Li-Ion Batteries” (filed May 24, 2019). All foregoing applications are incorporated herein by reference in their entireties for any and all purposes.

### TECHNICAL FIELD

The present disclosure relates to the field of lithium metal electrodes and components thereof, including MXene-polymer composite separators.

### BACKGROUND

Lithium (Li) metal anodes have attracted considerable interest due to their ultrahigh theoretical gravimetric capacity and low redox potential. Issues such as short lifespan and infinite volume expansion caused by the dendrite growth during Li plating/stripping, however, have held back the practical usage of such anodes. Moreover, the comparatively sharp dendrites can impale or otherwise disrupt battery separators, in turn leading to serious safety risks. Accordingly, there is a long-felt need in the art for improved battery materials.

### SUMMARY

In meeting the described long-felt needs, MXenes, a new family of two-dimensional (2D) materials with the general formula of Mₙ₊₁Xₙ, in which M represents an early transition metal and X represents a carbon or nitrogen atom with surface termination groups (—O, —OH, and —F), are a useful choice to induce uniform Li nucleation and a highly stable solid-electrolyte-inter-phase (SEI) derived from fluorine functional groups that can be present.

Without being bound to any theory of embodiment, one can adjust the number of fluorine functional groups and modulate the influence of fluorine on lithium nucleation and stability of SEI. Moreover, in view of the strongest reducibility of lithium in the elements, one can intercalate Mg²⁺ and Al³⁺ into the MXenes, which can be reduced and form Li—Mg or Li—Al alloy between the layers of MXenes. Without being bound to any particular theory, this will restrain the growth of lithium dendrite.

In meeting the long-felt needs in the field, the present disclosure provides a polymeric film coated on at least a portion of one or both sides with a MXene material.

Also provided are lithium-metal-anode separator, the separator comprising the composite according to the present disclosure.

Further provided are lithium-metal-anodes, the anode comprising a separator according to the present disclosure.

Also provided are lithium batteries, the battery comprising a separator as described herein or a lithium-metal-anode as described herein.

Additionally provided are electronic devices, the electronic devices comprising (a) a separator according to the present disclosure, (b) a lithium-metal anode according to the present disclosure, or (c) a lithium battery according to the present disclosure. The electronic device can be an energy storage device, a device used in electrocatalysis, an electromagnetic interference shielding or any combination thereof.

Further provided are a composite, separator, anode, battery, or electronic device of the present disclosure, characterized in a manner as described herein.

Also provided are methods, comprising forming a composite according to the present disclosure.

Additionally provided are methods, comprising: assembling an energy storage device that comprises a composite according to the present disclosure.

Further provided are methods, comprising operating an energy storage device that comprises a composite according to the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components.

The drawings illustrate generally, by way of example, but not by way of limitation, various aspects discussed in the present document. In the drawings:

FIG. 1 provides FESEM patterns of Ti₃C₂Tₓ-Celgard separator with different mass loading of Ti₃C₂Tₓ: (a) 0, (b) 0.05 mg, (c) 0.2 mg and (d) 0.5 mg.

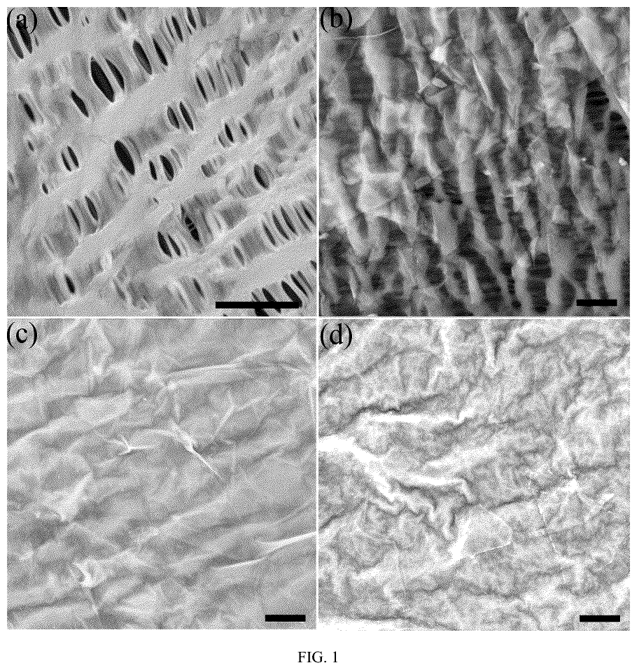

FIG. 2 provides example electrochemical performance of symmetric Li|Li cells with Celgard separator and Ti₃C₂Tₓ-Celgard separator at a current density of 1 mA cm⁻² and cycling capacity of 1 mAh cm⁻².

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

References herein to Celgard or Celgard 2500 refers to a commercial polypropylene product used in lithium system. It should be recognized that reference to such materials includes those embodiments with those materials, or generic of functionally equivalent versions thereof, as well as analogous polyethylene, or other polyalkylene polymers or copolymers typically used for this purpose. Celgard and Celgard 2500 are illustrative only and do not limit the scope of materials that can be used with the disclosed technology.

MXenes can be or can be derived from any of the compositions described in any one of U.S. patents application Ser. No. 14/094,966, International Applications PCT/US2012/043273, PCT/US2013/072733, PCT/US2015/051588, PCT/US2016/020216, or PCT/US2016/028,354. Specific such compositions are described elsewhere herein. In certain embodiments, the MXenes comprise substantially two-dimensional array of crystal cells, each crystal cell having an empirical formula of Mₙ₊₁Xₙ, or M′₂M″ₙXₙ₊₁, where M, M′, M″, and X are defined elsewhere herein. Those descriptions are incorporated here. In some independent embodiments, M is Ti or Ta. Additionally, or alternatively, X is C. The specification exemplifies the use of Ti₃C₂Tₓ as a precursor to, or as incorporated into, the nanocomposites

In certain aspects, MXenes are two-dimensional transition metal carbides, nitrides, or carbonitrides comprising at least one layer having first and second surfaces, each layer described by a formula Mₙ₊₁Xₙ Tₓ and comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, or 3; and
wherein Tₓ represents surface termination groups.

These so-called MXene compositions have been described in U.S. Pat. No. 9,193,595 and Application PCT/US2015/051588, filed Sep. 23, 2015, each of which is incorporated by reference herein in its entirety at least for its teaching of these compositions, their (electrical) properties, and their methods of making. That is, any such composition described in this disclosure is considered as applicable for use in the present applications and methods and within the scope of the present invention. For the sake of completeness, M can be at least one of Sc, Y, Lu, Ti, Zr, Hf, V, Nb, Ta, Cr, Mo, or W. In certain embodiments in this class, M is at least one Group IVB, Group VB, or Group VIB metal, preferably Ti, Mo, Nb, V, or Ta.

Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, SC₂N, Ti₂N, V₂N, Cr₂N, Cr₂N, Zr₂N, Nb₂N, Hf₂C, Ti₃N₂, V₃C₂, Ta₃C₂, Ti₄N₃, V₄C₃, Ta₄N₃ or a combination or mixture thereof. In particular embodiments, the Mₙ₊₁Xₙ structure comprises Ti₃C₂, Ti₂C, or Ta₄C₃. In some embodiments, M is Ti or Ta, and n is 1, 2, or 3, for example having an empirical formula Ti₃C₂ or Ti₂C. In some of these embodiments, at least one of said surfaces of each layer has surface terminations comprising hydroxide, oxide, sub-oxide, or a combination thereof.

In some embodiments, the MXene composition is described by a formula Mₙ₊₁Xₙ Tₓ, where Mₙ₊₁Xₙ are Ti₂CTx, Mo₂TiC₂Tx, Ti₃C₂Tₓ, or a combination thereof, and Tₓ is as described herein. Those embodiments wherein M is Ti, and n is 1 or 2, preferably 2, are especially preferred.

Additionally, or alternatively, in other embodiments, the articles of manufacture and methods use compositions, wherein the two-dimensional transition metal carbide, nitrides, or carbonitride comprises a composition having at least one layer having first and second surfaces, each layer comprising:
a substantially two-dimensional array of crystal cells,
each crystal cell having an empirical formula of M′₂M″ₙXₙ₊₁, such that each X is positioned within an octahedral array of M′ and M″, and where M″n are present as individual two-dimensional array of atoms intercalated (sandwiched) between a pair of two-dimensional arrays of M′ atoms,
wherein M′ and M″ are different Group IIIB, IVB, VB, or VIB metals (especially where M′ and M″ are Ti, V, Nb, Ta, Cr, Mo, or a combination thereof),
wherein each X is C, N, or a combination thereof, preferably C; and
n=1 or 2.

These compositions are described in, e.g., international patent application no. PCT/US2016/028354, filed Apr. 20, 2016, which is incorporated by reference herein in its entirety at least for its teaching of these compositions and their methods of making. In some embodiments, M′ is Mo, and M″ is Nb, Ta, Ti, or V, or a combination thereof. In other embodiments, n is 2, M′ is Mo, Ti, V, or a combination thereof, and M″ is Cr, Nb, Ta, Ti, or V, or a combination thereof. In still further embodiments, the empirical formula M′₂M″ₙXₙ₊₁ comprises Mo₂TiC₂, Mo₂VC₂, Mo₂TaC₂, MO₂NbC₂, MO₂Ti₂C₃, Cr₂TiC₂, Cr₂ VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises M₀₂Ti₂C₃, MO₂V₂C₃, MO₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably MO₂Ti₂C₃, MO₂V₂C₃, M₀₂Nb₂C₃, Mo₂Ta₂C₃, Ti₂Nb₂C₃, Ti₂Ta₂C₃, or V₂Ta₂C₃, or their nitride or carbonitride analogs.

Each of these compositions having empirical crystalline formulae Mₙ₊₁Xₙ or M′₂M″ₙXₙ₊₁ are described in terms of comprising at least one layer having first and second surfaces, each layer comprising a substantially two-dimensional array of crystal cells. In some embodiments, these compositions comprise layers of individual two-dimensional cells. In other embodiments, the compositions comprise a plurality of stacked layers.

In their free state, at least one of said surfaces of each layer of the MXene structures has surface terminations (optionally designated “Ts” or “Tₓ”) comprising alkoxide, carboxylate, halide, hydroxide, hydride, oxide, sub-oxide, nitride, sub-nitride, sulfide, thiol, or a combination thereof. In some embodiments, at least one of said surfaces of each layer has surface terminations comprising alkoxide, fluoride, hydroxide, oxide, sub-oxide, or a combination thereof.

In still other embodiments, both surfaces of each layer have said surface terminations comprising alkoxide, fluoride, hydroxide, oxide, sub-oxide, or a combination thereof. As used herein the terms “sub-oxide,” “sub-nitride,” or “sub-sulfide” is intended to connote a composition containing an amount reflecting a sub-stoichiometric or a mixed oxidation state of the M metal at the surface of oxide, nitride, or sulfide, respectively. For example, various forms of titania are known to exist as TiOx, where x can be less than 2. Accordingly, the surfaces of the present invention may also contain oxides, nitrides, or sulfides in similar sub-stoichiometric or mixed oxidation state amounts.

### EXEMPLARY EMBODIMENTS

The following exemplary embodiments are illustrative only and does not serve to limit the scope of the present disclosure or the appended claims.

Synthesis of Ti₃C₂Tₓ-Celgard Separator

Base separators were Celgard 2500™, and Ti₃C₂Tₓ was prepared by HCl—LiF method. The Ti₃C₂Tₓ-Celgard separator was prepared by vacuum filtration of 10 mL 0.05 mg mL⁻¹ Ti₃C₂Tₓ solution on one side of the Celgard 2500™ separator. The composite separator was dried in vacuum oven at 50° C. overnight. A Ti₃C₂Tₓ-Celgard™ separator can also be prepared by doctor blading after adjusting the concentration of Ti₃C₂Tₓ solution from 1 mg mL⁻¹ to 10 mg mL⁻¹. The thickness of Ti₃C₂Tₓ in the composite separator can be adjusted from 50 nm to 5 μm according to the mass loading of Ti₃C₂Tₓ.

Synthesis of Ti₃CNT-Celgard separator

The base separators used were Celgard 2500™. The Ti₃CNTₓ-Celgard™ separator was prepared by vacuum filtration of 0.02 mg mL⁻¹ Ti₃CNT solution on one side of the Celgard 2500™ separator. The composite separator was dried in vacuum oven at 40° C. overnight. A Ti₃CNTₓ-Celgard separator can be also be prepared by doctor blading after adjusting the concentration of Ti₃CNTₓ solution from 1 mg mL⁻¹ to 10 mg mL⁻¹. The thickness of Ti₃C₂Tₓ in the composite separator can be adjusted from 20 nm to 5 μm according to the mass loading of Ti₃CNTₓ.

Synthesis of Ti₂CTₓ-Celgard Separator

For this example, the separators used were Celgard 2500™, and Ti₂CTₓ was prepared by etching in 50% HF for 24 h and deintercalation in TMAOH for 12 h. Ti₂CTₓ-Celgard separator has been prepared by vacuum filtration of 0.01 mg mL⁻¹ Ti₂CTₓ solution on one side of the Celgard 2500 separator. The composite separator was dried in vacuum oven at room temperature overnight. Also, the Ti₂CTₓ-Celgard separator can be prepared by doctor blading after adjusting the concentration of Ti₂CTₓ solution from 1 mg mL⁻¹ to 10 mg mL⁻¹. The thickness of Ti₃C₂Tₓ in the composite separator can be adjusted from 500 nm to 10 μm according to the mass loading of Ti₂CTₓ.

Synthesis of V₂CTₓ-Celgard Separator

The separators used were Celgard 2500™, and V₂CTₓ was prepared by etching in 25% HF for 24 h and deintercalation in TMAOH for 12 h. The V₂CTₓ-Celgard separator was prepared by vacuum filtration of 0.05 mg mL⁻¹ V₂CTₓ solution on one side of the Celgard 2500™ separator. The composite separator was then dried in vacuum oven at 50° C. overnight. The V₂CTₓ-Celgard™ separator can be prepared by doctor blading after adjusting the concentration of V₂CTₓ solution from 1 mg mL⁻¹ to 5 mg mL⁻¹. The thickness of V₂CTₓ in the composite separator can be adjusted from 100 nm to 5 μm according to the mass loading of V₂CTₓ.

Synthesis of Nb₄C₃Tₓ-Celgard separator

Nb₄C₃Tₓ was prepared by etching in 30% HF for 18 h and deintercalation in TMAOH for 6 h. A Nb₄C₃Tₓ-Celgard™ separator was prepared by doctor blading after adjusting the concentration of Nb₄C₃Tₓ solution from 1 mg mL⁻¹ to 5 mg mL⁻¹. The thickness of Nb₄C₃Tₓ in the composite separator could be adjusted from 1 μm to 5 μm according to the mass loading of Nb₄C₃Tₓ. The composite separator was dried in vacuum oven at 50° C. overnight.

### Applications in Lithium Metal Anodes

MXenes-Celgard separators are useful as separators for dendrite-free lithium-metal-anodes. To evaluate the life of lithium metal anodes, Li|Li symmetric coin cells were assembled with 2032 coin-type cells with pristine separator and MXenes-Celgard separators; 10 mm diameter and 50 μm thick Li metal film were used. The electrolytes were 1.0 M Li bis(trifluoromethane-sulfonyl)imide dissolved in DOL/DME solvents with 1.0 weight % lithium nitrate (LiNO₃). Lithium was plated and stripped for 2 hour per cycle in Li|Li cells with the capacity of 0.5 mAh cm⁻². All batteries were assembled in an Ar-filled glove box with O₂ and H₂O content below 0.5 parts per million.

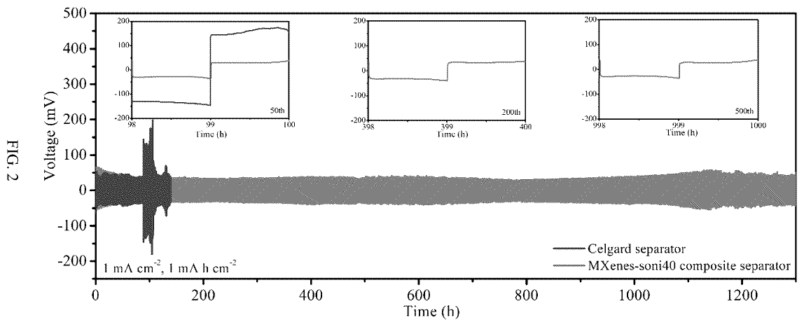

As shown in FIG. 2, we tested the cycling performance of symmetric Li|Li cells with Celgard separator and Ti₃C₂Tₓ-Celgard separator at a current density of 1 mA cm⁻² and cycling capacity of 1 mAh cm⁻². The life of symmetric Li|Li cells with Ti₃C₂Tₓ-Celgard separator reached up to 1300 h, while the life of symmetric Li|Li cells with Celgard separator was only about 100 h. Without being bound to any particular theory, the improved performance of the MXene-containing separators may be attributable to the presence of the MXene materials.

### Aspects

The following Aspects are illustrative only and do not serve to limit the scope of the present disclosure or of the appended claims.

Aspect 1. A composite, comprising: a polymeric film coated on at least a portion of one or both sides with a MXene material. The film can be completely coated (on one or both sides) with the MXene material, but this is not a requirement, as the film can include a region (e.g., a border or frame) that is not coated with the MXene material.

The composite can itself be in film form, e.g., a free-standing film. The composite can also be in a roll form.

As mentioned elsewhere herein, one can include and modulate the proportion of halogen (e.g., fluorine functional groups) present on a MXene. One can also intercalate Mg²⁺ and Al³⁺ (or other metal ions) into the MXenes, which ions can in turn be reduced and form Li—Mg or Li—Al alloy between the layers of MXenes. Without being bound to any particular theory, this may act to restrain the growth of lithium dendrite. Thus, the disclosed films can include MXenes having halogen (e.g., fluorine) termination groups, as well as additional metal ions (besides Li metal) intercalated into the MXenes; the films can also include Li-metal alloys (e.g., Li—Mg, Li—Al alloys) present within the MXenes.

The polymeric film can be permeable, e.g., be porous. In a porous film, pores can have an average diameter of greater than about 50 Angstroms, or even greater than 100 Angstroms. The polymeric film can, in some embodiments, have a thickness in the range of from about 1 micrometer to about 25 micrometers or even from about 1 micrometers to about 50 micrometers. Thicknesses of from about 25 to about 50 micrometers are considered suitable for some applications.

The polymeric film can be, e.g., a polyalkylene. Some example such materials are, e.g., polyethylene, polypropylene, poly(tetrafluoroethylene), polyvinyl chloride, and the like.

Aspect 2. The composite of Aspect 1, wherein the polymeric film comprises polypropylene.

Aspect 3. The composite of any one of Aspects 1-2, wherein the MXene comprises a substantially two-dimensional array of crystal cells, each crystal cell having an empirical formula of Mₙ₊₁Xₙ, or M′₂M″ₙXₙ₊₁. MXene materials be can any of the MXene configurations described elsewhere herein, e.g., Mₙ₊₁Xₙ Tₓ.

Aspect 4. The composite of any one of Aspects 1-3, wherein the composite is configured as a separator for a lithium-metal-anode.

Aspect 5. A lithium-metal-anode separator, the separator comprising the composite according to any one of Aspects 1-4.

Aspect 6. A lithium-metal-anode, the anode comprising a separator according to Aspect 5.

Aspect 7. A lithium battery, the battery comprising a separator of Aspect 5 or the lithium-metal-anode of Aspect 6.

Aspect 8. An electronic device, the electronic device comprising (a) a separator according to Aspect 5, (b) a lithium-metal anode according to Aspect 6, or (c) a lithium battery according to Aspect 7, wherein the electronic device is an energy storage device, a device used in electrocatalysis, an electromagnetic interference shielding or any combination thereof. (An electronic device can comprise a composite according to any of Aspects 1-2.)

Aspect 9. A composite, separator, anode, battery, or electronic device of any one of Aspects 1-8, characterized in a manner as described herein.

Aspect 10. A method, comprising forming a composite according to Aspect 1. Such methods can include, e.g., applying a MXene material to a polymeric film so as to coat at least a portion of one or both sides of the polymeric film. The methods can also include modulating the thickness of the MXene material. Such modulation can be accomplished by, e.g., doctor blading, modulating the mass loading of the MXene material, and the like.

Aspect 11. A method, comprising: assembling an energy storage device that comprises a composite film according to any one of Aspects 1-4. Such energy storage devices can be, e.g., Li ion batteries. Exemplary methods are described elsewhere herein; such methods can include, e.g., coating the MXene material onto the polymeric film, immersing the polymeric film in a solution that comprise the MXene material, and the like. Such a method can be performed in a continuous process, but can also be performed in a batch process.

Aspect 12. A method, comprising operating an energy storage device that comprises a composite according to any one of Aspects 1-4. Such operation can include, e.g., charging the device, discharging the device, and the like. Such a device can be operated to power a load, e.g., a computing device, a motor, and the like.

### REFERENCES

The following references are listed for convenience only. The inclusion of these references is not an acknowledgment that they are material in any way to the patentability of the disclosed technology.
1. Gogotsi, Y. G.; Andrievski, R. A. (Eds.), Materials Science of Carbides, Nitrides and Borides, NATO Science Series (Kluwer, Dordrecht, N L 1999).
2. Alhabeb, M. et al. Guidelines for Synthesis and Processing of Two-Dimensional Titanium Carbide (Ti₃C₂Tₓ MXene). Chem. Mater. 29, 7633-7644 (2017).
3. Liang, X. et al. A facile Surface Chemistry Route to a Stabilized Lithium Metal Anode. Nat. Energy. 2 17119 (2017).

1. A composite, comprising:
a polymeric film coated on one or both sides with a MXene material.

2. The composite of claim 1, wherein the polymeric film comprises polypropylene.

3. The composite of claim 1, wherein the MXene comprises a substantially two-dimensional array of crystal cells, each crystal cell having an empirical formula of Mₙ₊₁Xₙ, or M′₂M″ₙXₙ₊₁.

4. The composite of claim 1, wherein the composite is configured as a separator for a lithium-metal-anode.

5. A lithium-metal-anode separator, the separator comprising the composite according to claim 1.

6. A lithium-metal-anode, the anode comprising a separator according to claim 5.

7. A lithium battery, the battery comprising a separator according to claim 1.

8. A lithium battery, the battery comprising a lithium-metal anode according to claim 6.

9. An electronic device, the electronic device comprising a composite according to claim 1, wherein the electronic device is an energy storage device, a device used in electrocatalysis, an electromagnetic interference shielding or any combination thereof.

10. A composite, separator, anode, battery, or electronic device of claim 1, characterized in a manner as described herein.

11. A method, comprising forming a composite according to claim 1.

12. A method, comprising assembling an energy storage device that comprises a composite according to claim 1.

13. A method, comprising operating an energy storage device that comprises a composite according to claim 1.
